(19) United States
(12) Patent Application Publication
(10) Pub. No.: US 2010/0295966 A1
(43) Pub. Date: Nov. 25, 2010

(54) DIGITAL VIDEO CAMERA WITH HIGH RESOLUTION IMAGING SYSTEM

(76) Inventor: John FURLAN, Belmont, CA (US)

Correspondence Address: PATTERSON & SHERIDAN, LLP/CISC, 3040 POST OAK BLVD., SUITE 1500, HOUSTON, TX, 77056-6582, US

(21) Appl. No.: 12/759,586

(22) Filed: Apr. 13, 2010

Related U.S. Application Data
(60) Provisional application No. 61/179,651, filed on May 19, 2009.

(51) Int. Cl. H04N 5/76

(52) U.S. Cl. 348/231.2; 348/E05.031

(57) ABSTRACT

A method that includes receiving image data from a digital image sensor that is associated with a series of video frames. The method further includes processing a first portion of the image data to generate a first video frame included in a video sequence, where the first video frame has a first resolution, storing the first video frame in a first memory location, processing a second portion of the image data to generate an image having a second resolution that is greater than the first resolution, and storing the second video frame in a second memory location.

### CROSS-REFERENCE TO RELATED APPLICATIONS

This application claims benefit of U.S. provisional patent application Ser. No. 61/179,651 filed on May 19, 2009, which is hereby incorporated herein by reference.

### BACKGROUND OF THE INVENTION

Digital still cameras and digital video cameras have become popular with the public. Digital still cameras provide a user with the ability to capture and store a number of high-resolution digital images and then print the images or send a copy of the images to others, for example, using an e-mail program or a photo-sharing website. Digital video cameras enable a user to capture video footage, which can be viewed on a television, uploaded to video sharing websites, or recorded onto a recording medium such as a digital versatile disc (DVD). Typically, video footage is captured at a lower resolution than that associated with still images.

Some digital cameras provide a user with the capability of shooting both still images and video footage. Typically, a user may select a shooting mode using a user input device mounted on the camera, for example, a wheel with icons representing different shooting modes. These modes can include automatic still image capture; portrait still image capture mode, close up still image capture mode, video capture mode, and the like. Selecting a still image capture mode may result in the camera operating as a digital still camera. Selecting a video capture mode may result in the camera operating as a digital video camera. Thus, these cameras offer the user the capability of recording video or taking still pictures. Other digital video cameras provide the functionality of capturing still images during the shooting of video footage. For example, a user can push a shutter button to capture a still image during shooting of the video footage. In addition to capturing still images using a video camera based on user settings or user input during recording, video software is available that enables a user to pause a video during playback on a computer and extract a frame as a still image. Typically, a user navigates forward and backward through the video, frame by frame, to find a suitable frame to capture as a still image. Using this software-based method, the resolution of the still image is generally limited to the resolution of the video footage (e.g., 640×480 or 1280×720), which may be low resolution compared to the resolution of still images having a file size of several megapixels.

Despite the functionality provided by some digital cameras, a need exists in the art for improved methods and systems for capturing still images and video footage.

### SUMMARY

Embodiments of the present invention relate generally to video systems. More specifically, embodiments of the present invention relate to methods and systems for capturing still images while recording digital video footage. Merely by way of example, the embodiments of the present invention have been applied to a digital video camera including a high-resolution sensor and a video processor configured to capture high-resolution still images and lower resolution video footage. The methods and techniques can be applied to other mobile electronic devices such as mobile phones, personal digital assistants (PDAs), and the like.

According to an embodiment of the present invention, a method of capturing a duration of continuous video footage is provided. The continuous video footage is characterized by a frame rate. The method includes receiving a signal from an image sensor, processing a first portion of the signal to generate a first section of the continuous video footage comprising a first frame and a last frame, and storing the first section of the continuous video footage in a memory. The method also includes processing a second portion of the signal to generate a still image independent of a user input during receiving the signal from the image sensor and storing the still image in the memory. The method further includes processing a third portion of the signal to generate a second section of the continuous video footage comprising a first frame and a last frame and storing the second section of the continuous video footage in the memory. The first frame of the second section of the continuous video footage follows the last frame of the first section of the continuous video footage sequentially.

Another embodiment of the present invention provides a method that includes receiving image data from a digital image sensor that is associated with a series of video frames. The method further includes processing a first portion of the image data to generate a first video frame included in a video sequence, where the first video frame has a first resolution, storing the first video frame in a first memory location, processing a second portion of the image data to generate an image having a second resolution that is greater than the first resolution, and storing the second video frame in a second memory location.

According to yet another embodiment of the present invention, a camcorder is provided. The camcorder includes a single user input device for recording both video footage and still images and an image sensor characterized by a maximum pixel resolution. The camcorder also includes a first memory coupled to the image sensor and a processor coupled to the first memory. The processor includes a video codec processor operable to generate video at a first resolution less than the maximum pixel resolution and an image processor operable to generate still images at a second resolution higher than the first resolution. The camcorder further includes a second memory coupled to the processor. The camcorder has no mechanical video footage/still image mode selector.

Many benefits are achieved by way of the embodiments of the present invention over conventional techniques. For example, embodiments of the present invention allow a user to capture a high-quality (i.e., high-resolution) still image at multiple times throughout video footage, rather than from only a single frame associated with an instant in time. Additionally, embodiments enable a user to extract high-resolution still images from video footage after such footage has been recorded. This is in contrast with conventional cameras that require a user to take active steps to capture still images during the recording process. Moreover, the embodiments of the present invention described herein do not require a user to actively press a button while recording video footage in order to capture a high-quality still image from the scene being recorded. These and other embodiments of the invention along with many of its advantages and features are described in more detail in conjunction with the text below and attached figures.

### BRIEF DESCRIPTION OF THE DRAWINGS

FIG. 1A is a simplified perspective drawing of the front of a digital video camera, according to an embodiment of the present invention;

FIG. 1B is a simplified perspective drawing of the back of the digital video camera illustrated in FIG. 1A;

FIG. 2 is a simplified block diagram of a digital video camera, according to an embodiment of the present invention;

FIG. 3 is a simplified block diagram of a digital video camera, according to another embodiment of the present invention;

FIG. 4 is a simplified flowchart illustrating a method of capturing still images, according to an embodiment of the present invention; and

FIG. 5 is a simplified flowchart illustrating a method of operating a digital video camera, according to another embodiment of the present invention.

### DESCRIPTION OF EXAMPLE EMBODIMENTS

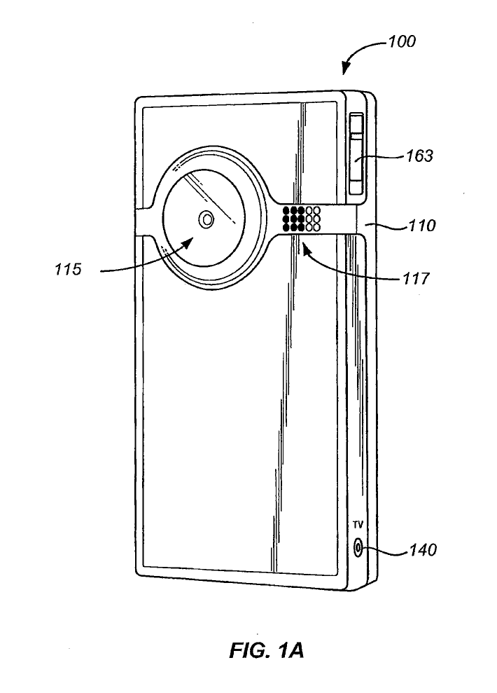

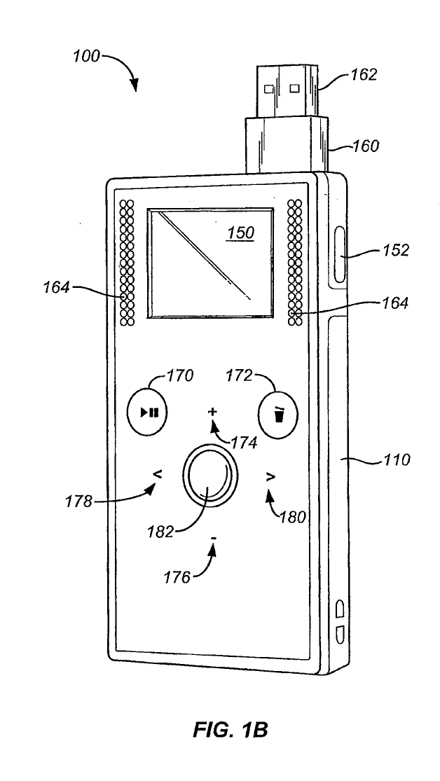

FIG. 1A is a simplified perspective drawing of the front of a digital video camera 100, according to an embodiment of the present invention. The digital video camera 100, also referred to as a digital camcorder or camcorder, includes a camera body 110 that is designed to enclose the internal components of the digital video camera 100. Camera body 110 may also be designed to address such considerations as ease of use and durability. For instance, camera body 110 may be sized so that the digital video camera 100 can fit easily into a user's pocket. Camera body 110 may be manufactured from a hard plastic, metal, or other durable material to improve durability of the digital video camera. In one embodiment, camera body 110 is manufactured from a durable material in order to protect the internal components of the digital video camera 100 from physical shock, moisture, and other harmful elements.

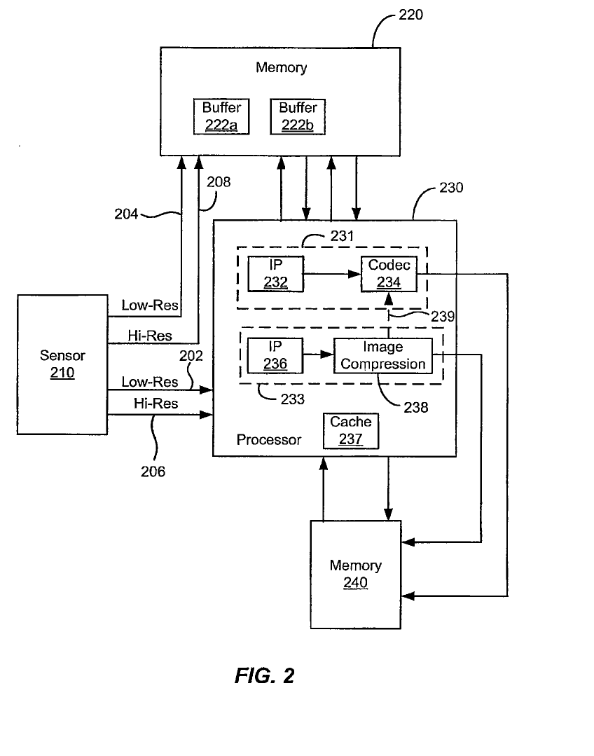

The digital video camera 100 includes a lens 115 that projects an image onto a digital video image sensor (not shown) located inside the camera body 110. Additional description related to the digital video image sensor is provided in relation to FIG. 2. The image capture components, including the lens 115 and the digital video image sensor, are capable of capturing digital video footage at resolutions and frame rates determined by the particular application, for example, standard definition (SD) video at 640×480 or high-definition (HD) video such as 720p, 1080i, or 1080p. Frame rates of 24 frames per second (fps), 30 fps, 60 fps, or the like are included within the scope of embodiments of the present invention. The microphone and audio sensor 117 capture the sound corresponding to the captured video footage.

The digital video camera 100 may be coupled to a television or other video monitor through television connector 140 in order to display still images and video clips on a television (not shown).

FIG. 1B is a simplified perspective drawing of the back of the digital video camera 100 illustrated in FIG. 1A. The digital video camera 100 includes a number of user interfaces/controls as described below. As illustrated in FIG. 1B, the digital video camera 100 includes the camera body 110, a digital viewfinder 150, a data connector 162 attached to an arm 160, and audio speakers 164. The user interface buttons/controls include a power button 152, a play/pause button 170, a delete button 172, and a record button 182. The illustrated interface buttons also include a previous button 178, a next button 180, a zoom in/volume up button 174, and a zoom out/volume down button 176. In the illustrated embodiment, all of the interface buttons with the exception of the record button 182 and power button 152 are touch-sensitive capacitive buttons, but may be implemented in any technically feasible manner depending on the particular embodiment.

In the embodiment illustrated in FIG. 1B, the digital video camera 100 includes an arm 160 that is permanently attached to the camera body 110. A data connector 162 is permanently attached to the arm 160. The arm 160 and data connector 162 can retract into the camera body 110, or extend from the camera body 110 in response to actuation of switch 163 illustrated in FIG. 1A. In one embodiment, the data connector 162 complies with the Universal Serial Bus (USB) standard for data transfer. In another embodiment, the data connector 162 complies with the Institute of Electrical and Electronics Engineers (IEEE) 1394 interface standard. In FIG. 1A, the arm 160 and data connector 162 are illustrated in the retracted position; whereas, in FIG. 1B, the arm 160 and data connector 162 are illustrated in the extended position. When in the extended position, the arm 160 and data connector 162 comprise dimensions that provide sufficient clearance so that the data connector 162 can be inserted directly into an appropriate receptacle on an external device such as a computer system or a processing station. After the data connector 162 is connected to the external device, data can be transferred to and from the digital video camera 100 to the external device.

The digital viewfinder 150 allows a user to frame a scene to be captured as digital video footage. A user can also use the digital viewfinder 150 to view the scene while the capture is taking place. The display of the digital viewfinder 150 also allows the user to review video data that has been recorded in the non-volatile memory for data storage provided in the digital video camera. Thus, the digital viewfinder 150 is used to frame the subject prior to and during video capture, display video footage during video capture, and display video footage during playback, among other things. Control of the playback is provided through the user interface buttons described above, i.e., the play/pause button 170 and other buttons. The digital viewfinder 150 may be an active electronic component such as an active matrix or reflective liquid crystal display (LCD) serving as a high-quality multi-shade display capable of showing dual-tone or full color pictures and/or video segments.

In addition to video capture and display functionality, the digital viewfinder 150 can be used to visually communicate information, such as displaying current camera status, remaining recording time, battery level, low lighting conditions, and other similar information. Additionally, during initial operation, setup functions can be accessed using the user interface buttons and displayed on the digital viewfinder 150. Additional description related to digital video cameras is provided in co-pending and commonly assigned U.S. patent application Ser. No. 11/497,039, filed on Jul. 31, 2006, the disclosure of which is hereby incorporated herein by reference in its entirety for all purposes.

FIG. 2 is a simplified block diagram of a digital video camera, according to an embodiment of the present invention. The digital video camera includes a digital video image sensor 210 that effectively can be run in two modes: a still image capture mode that provides still images at high-resolution (e.g., the full resolution of the sensor) or a video capture mode providing video footage at a lower resolution than the full resolution of the sensor and at a pre-determined frame rate. For example, the full resolution of the sensor could be 8 megapixels (MP) and the video footage could be 2 MP at 30 frames per second. In the example discussed herein, the resolution of the sensor 210 is 8 MP. In referring to two modes, the sensor itself does not necessarily have differing modes of operation, but processing can provide the described modes of operation by receiving information from the sensor 210 and then producing the information described herein. However, this particular resolution is merely used as an example and embodiments of the present invention are not limited to this particular resolution. In other embodiments, the resolution of the sensor is greater than or less than 8 MP. Thus, although 8 MP is used as an example throughout the present specification, other suitable resolutions are included within the scope of embodiments of the present invention. Also, binning, windowing, combinations thereof, or other suitable methods of providing a video stream at a resolution less than the full resolution of the sensor 210 can be utilized in the video capture mode. This process can be referred to as operating in a decimated mode in which an image sensor with a pixel resolution higher than the pixel resolution of the video footage is used during video capture and the pixels of the image sensor are not mapped 1-to-1 with the pixels in the final video footage. Such decimation can be performed by the sensor or by ancillary hardware and/or software.

In various embodiments, the digital video image sensor may be a Complementary Metal Oxide Semiconductor (CMOS) sensor or a Charge Coupled Device (CCD) with 3,264×2,448 pixel resolution or other pixel configurations. The digital video image sensor 210 quantifies the variable shades of light focused on the digital video image sensor 210 by the optical components (including lens 115) into data arrays representing a discrete number of colors. In one embodiment, the digital video image sensor 210 is at least capable of operation between night-time or dusk conditions and brighter light conditions, such as 10 lux to 10,000 lux, where 1 lux is a measure of illumination equivalent to 1 lumen per square meter. The digital video image sensor 210 may be capable of operating in lighting conditions dimmer than 10 lux and brighter than 10,000 lux. The digital video image sensor 210 may also contain an application-specific integrated circuit (ASIC) to provide several optional features such as automatic exposure adjustment, automatic white balance, and automatic gamma compensation, and the like. The automatic exposure adjustment changes the light sensitivity of digital video image sensor 210 based on the lighting conditions. The automatic white balance balances the hue of the color spectrum represented in the data array.

Signals from sensor 210 are provided to processor 230. The processor 230 can be a micro-controller, an ASIC, or other suitable processor. In one implementation, the video frames from the sensor are in the form of RAW video frames (represented by a low-resolution (Low-Res) stream 202 in FIG. 2). In the processor 230, also referred to as a central processor or CPU, image processing and/or other logic is used to process the stream of data that is generated by the image and/or audio capturing components and transform the captured video content (e.g., the RAW video data) to useable formats in pre-defined file structures. The sensor data provided to the processor 230 is sent to an image processing (IP) engine 232. The IP engine 232 utilizes memory 220 and buffers 222a, 222b, etc. in the memory 220 during image processing operations. Two buffers are illustrated, but additional buffers or fewer buffers may be utilized as will be evident to one of skill in the art. The memory 220 is typically a dynamic random access memory (RAM) (e.g., double-data-rate synchronous dynamic random access memory (DDR SDRAM). The data is passed to/from processor 230 to/from memory 220 during the image processing operations.

The processor 230 may execute firmware instructions stored in memory 240 (e.g., a non-volatile memory) and copy the instructions to memory 220 for execution. The processor 230 also controls the operation of the digital video camera 100. As discussed above, the central processor 230 may also use portions of memory 220 (e.g., buffers 222a, 222b) to convert the raw data into captured video content in a proprietary file format or a standard video file format. Compression logic is typically used to compress the video data prior to the storing of the captured video data in the memory 240. The compression logic may use video and audio compression techniques such as Moving Pictures Experts Group (MPEG), MPEG-1, MPEG-2, MPEG-4, Motion Joint Photographic Experts Group (M-JPEG), Pulse Code Modulation (PCM), similar compression standards, or variants thereof. Such processing can include encoding or transcoding.

The compression logic may compress video and audio data by compression of composed video images, compression of three video channels, red, green, blue, (RGB), compression of raw sensor data in separate video channels, red, green-one, blue, green-two (R, G1, B, G2), down sampling the frame-rate of a video stream, or by conducting other similar compression techniques.

The internal memory components are used to both store the stream of video data as well as to develop the stream of video data. The internal memory components are also used during execution of code necessary to operate the digital video camera 100. Digital video camera 100 may contain multiple types of internal memory components, each type customized for a different purpose and cost. The two main types of internal memory may include volatile memory, such as synchronous dynamic random access memory (SDRAM), dynamic random access memory (DRAM), and non-volatile memory, such as flash memory and write-once memory. Non-volatile memory for data storage, such as a portion of a hard disk or a flash memory module and/or non-volatile memory for firmware and/or settings, is an example of non-volatile memory. Volatile memory for data processing and volatile memory for code execution are examples of volatile memories.

The non-volatile memory for data storage (e.g., memory 240) may be used in the digital video camera 100 to store any type of data. For example, the non-volatile memory may be used to store digital video footage captured using the digital video image sensor 210, thumbnail files associated with digital video files, or a resident software application. The non-volatile memory may also store still photo files, audio files, or any other type of data. In one embodiment, the non-volatile memory may include non-volatile memory units such as 512 megabyte (MB) NAND flash memory modules, 1 gigabyte (GB), 2 GB, 4 GB, 8 GB, 16 GB, 32 GB, 64 GB, or another type of flash memory modules, so that the contents of the non-volatile memory are preserved even when no power is being supplied to the non-volatile memory. The non-volatile memory may also utilize storage technologies besides flash memory technology. For instance, the non-volatile memory could also be implemented by a hard disk drive or optical media such as a writable compact disc (CD) or DVD. In one embodiment, the non-volatile memory may be removable from the digital video camera 100. A user can then change the capacity or the content of memory available to the digital video camera 100. In other embodiments, the nonvolatile memory may not be removable from the digital camera 100. In a digital video camera 100 having a non-removable non-volatile memory, the use of the digital video camera 100 is simplified because non-volatile memory may typically be available for storage of digital video footage or other data.

As illustrated in FIG. 2, the data from the sensor 210 may also be provided directly to memory 220 (Low-Res stream 204). From the memory, the data may be sent to the IP engine 232, which utilizes memory 220 during the image processing operations. Depending on the application and the hardware implementation, the actual data path can vary. The IP engine 232 produces an output that is suitable for input into the codec processor 234, which may perform encoding and/or transcoding. In one embodiment, the codec processor implements the ITU-T (International Telecommunication Union) H.264 video compression codec to generate compressed video footage. The codec processor 234 may also utilize one or more buffers in memory 220 during operation. Additionally, a local cache 237 in the processor may be used to temporarily store data during operation on data by processor 230. In one embodiment, during the image processing and video compression processes, the signal from sensor 210 is converted from RAW to RGB to YUV to a compressed format. In some embodiments, processing of the video data on a frame-by-frame basis may involve cycles of processing and caching of the data, represented by the arrows providing for bi-directional data flow between processor 230 and memory 220. One of ordinary skill in the art would recognize many variations, modifications, and alternatives. The compressed video footage output from codec processor 234 (e.g., H.264 video) is written to memory 240, which is typically a non-volatile memory such as NAND flash memory.

Although high-resolution sensors are routinely used in digital still cameras, it is presently difficult to economically process such high-resolution images at the frame rates (e.g., 30 fps to 60 fps) associated with conventional video standards. As discussed above, such processing can include transcoding and storage of the video footage. Some digital video cameras utilize a high-resolution sensor when operating in a still image capture mode and then effectively operate the high-resolution sensor in a reduced resolution mode during capture of video footage. As described above, utilizing techniques such as windowing or binning, it is possible to use a high-resolution sensor (e.g., 8 MP) to capture lower resolution video footage (e.g., 2 MP).

Another technique to obtain still images is to extract still images from video footage using post-capture software. However, when using this approach, the presence of a high-resolution sensor in the camera is of little use in obtaining high-resolution still images. Since the resolution of the video frame captured using binning or another sampling approach is much lower than the maximum resolution of the sensor, a still image extracted from a single frame of video may be at the lower resolution of the video frame, rather than at the maximum resolution of the sensor. This results in relatively poor quality still images.

Embodiments of the present invention solve the aforementioned problems by capturing both video footage at low resolution in terms of the maximum resolution of the digital video image sensor, and high-resolution still images at resolutions up to the maximum resolution of the sensor using sensor 210. As an example, sensor data at the full resolution (8 MB) of the sensor is provided from the sensor to either processor 230 (e.g., high-resolution (Hi-Res) stream 206), memory 220 (e.g., Hi-Res stream 208), or both at an interval less frequent than the video frame rate. The high-resolution still images can be automatically captured at pre-determined intervals during video recording. The pre-determined interval may be regular (e.g., once per second) or varied depending on the embodiment.

Utilizing one embodiment described herein, video footage may include not only images for display as part of the video, but also high-resolution images within the normal sequence of captured frames. Thus, not only the video footage is available for user playback, but a series of high-resolution still images may be available for the user to extract from the video footage. It should be noted that in some embodiments, the user may not extract the images, but image extraction may be performed automatically, for example, an album of snapshots may be collected from each video captured. The quality of the still images may be much higher than the resolution of the video footage. The interval at which high-quality images are captured may depend on the limits of the hardware and memory utilized in the digital video camera, or by preferences selected by the user within limits of the device.

Image processing of the high-resolution sensor data by the IP engine 236 and image compression engine 238 may result in conversion of the data from RAW to RGB to YUV to JPEG (Joint Photographic Experts Group) or other format suitable for image storage. Still image data is sent from the sensor to the processor or the memory at a frame rate less than the frame rate of the video data (i.e., at less than 30 fps, for example, 1 fps). Because of the reduced rate at which still images are captured in comparison to the video footage, the image processing and image compression operations for the still images can effectively be performed in the background while the camera is generating the video footage in accordance with normal digital video camera operations (e.g., a fully compliant H.264 video stream). Many processors provide the processing resources to process and compress a still image captured at one frame per second in less time than the delay between subsequent still images (e.g., one second). Thus, for these processors, the still image capture and processing is effectively performed in the background while the normal video signal is captured and stored. Image processing and compression of the still image can also be performed in a tiled manner, with portions of the image processed sequentially. The embodiment of the present invention illustrated in FIG. 2 provides two image processing cores: a first core or pipeline 231 for video footage and a second core or pipeline 233 for still images. Processor technologies such as threading may be utilized as part of the operation of processor 230. One of ordinary skill in the art would recognize many variations, modifications, and alternatives.

In practice, the JPEG or other compressed still image data from image compression engine 238 can be written to a buffer in memory 220 (e.g., DDR) and then to memory 240 as a separate file. Alternatively, in embodiments in which the compressed still image is stored in the video bitstream, codec 234 may pull the compressed still image (e.g., a JPEG) from a buffer in memory 220 and then encode the still image data in the bitstream, which may be stored in memory 220 before being stored in memory 240. Thus, referring to FIG. 2, arrow 239 running from the image compression engine 238 to the codec 234 represents storage of the compressed still image (e.g., a JPEG file) in the video footage bitstream. For example, H.264, among other standards, includes the concept of user data, which allows arbitrary data such as a compressed still image to be encoded along with the video footage data. During decoding for display of the video footage, the decoder recognizes the code for user data and then skips the arbitrary data, resuming decoding at the next video frame. Thus, embodiments of the present invention provide backward compatibility with conventional video encoders and decoders. Alternatively, a customized decoder could recognize the code for user data and then extract the arbitrary data for storage in memory or display as appropriate to the particular application. For example, using a custom decoder and/or video software, the high-resolution still image could be detected, extracted, and then presented to the user for use as a snapshot.

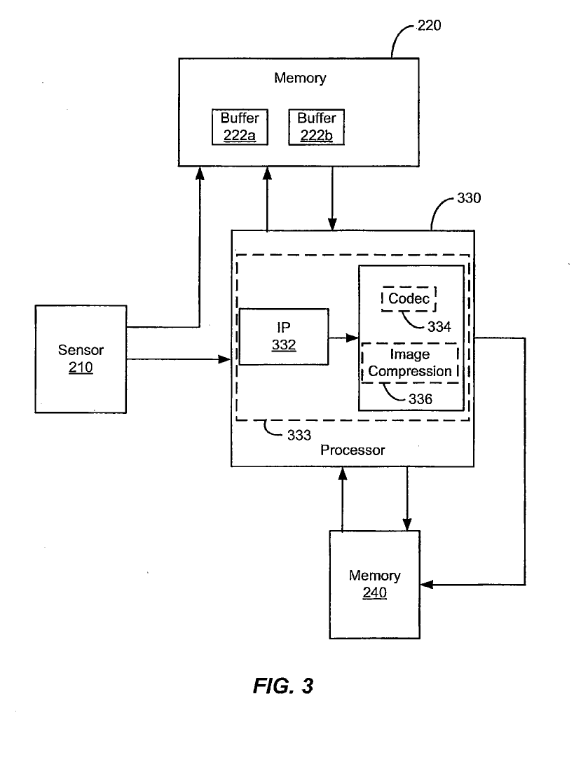

FIG. 3 is a simplified block diagram of a digital video camera, according to another embodiment of the present invention. FIG. 3 illustrates an embodiment in which the processor 330 utilizes a single processing core 333 that includes an image processor 332, which may perform image processing for both video footage and still images, a codec 334 for compression/transcoding/etc. of the video footage, and an image compression engine 336 for compression of the still images. Although the various elements in processing core 333 are illustrated as separate entities, the various functions may be combined or subdivided into additional processing units as will be evident to one of skill in the art.

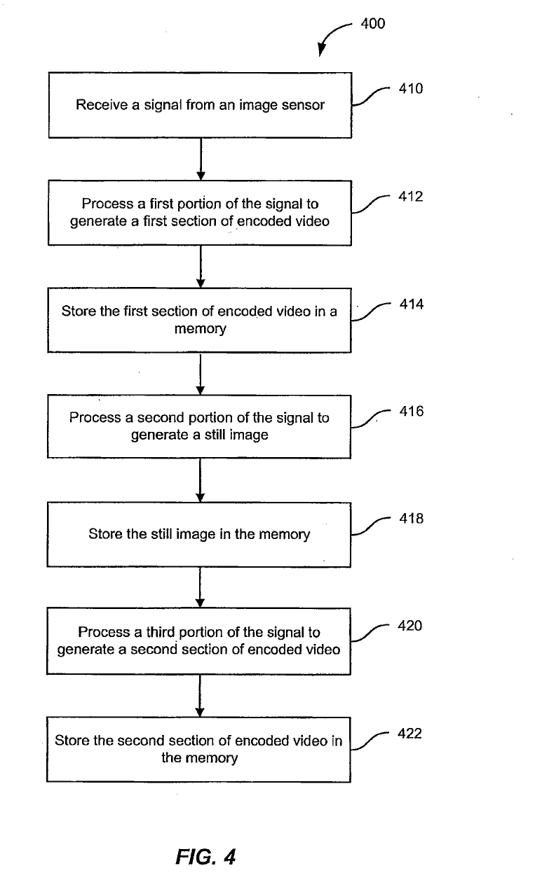

FIG. 4 is a simplified flowchart illustrating a method 400 of capturing a duration of continuous video footage, according to an embodiment of the present invention. The method 400 is may be practiced using the digital video camera described herein. The video footage may be characterized by a frame rate, for example, 24 fps, 30 fps, 60 fps, or the like. The method 400 includes receiving a signal from an image sensor (410). The image sensor, which may be digital video image sensor 210, receives an optical signal and generates a digital signal associated with the series of images captured by the image sensor. The method 400 also includes processing a first portion of the signal to generate a first section of continuous video footage (412). In a specific embodiment, processing the first portion of the video footage includes encoding the video signal using an H.264 codec. One way to implement embodiments of the invention using the H.264 codec is to have each I-Frame of the video be a high-resolution frame and subsequent P-Frames and B-Frames be at the lower, binned, or otherwise sub-sampled resolution. For example, the I-Frames may be 3 MP or 5 MP frames, whereas subsequent frames could have a lower resolution such as 1 MP or 2 MP. In some embodiments, the overall video sequence would then be at the higher resolution since intermediate frames could be interpolated using the higher resolution frames.

The first section of the continuous video footage includes a first frame and a last frame. The first section of continuous video footage represents a series of consecutive or sequential video frames running from a first time associated with the first frame to a second time associated with the last frame. The duration of the first section is equal to the number of frames in the first section divided by the frame rate of the video footage. Processing of the first portion of the signal may include image processing, compression, encoding, and other suitable techniques. Additionally, in some embodiments, some of the video frames are captured at full resolution and then encoded into the stream as a frame of video or adjunct to the stream of video. The method also includes storing the first section of the continuous video footage in a memory (414), for example, a non-volatile memory provided in the digital video camera. In some embodiments, the video is stored in-band in the stream, i.e., either embedded as an I-Frame of the video or as a comment or similar header that marks the data separate from the video stream.

In some embodiments, the method 400 further includes processing a second portion of the signal to generate a still image (416). The still image is generated independent of a user input while the digital video camera is receiving the signal from the image sensor. In some embodiments the second portion of the signal comprises the first portion of the signal. In other embodiments, the second portion of the signal comprises part of the first portion of the signal. In still further embodiments, the second portion of the signal is separate from the first portion of the signal and does not comprise any part of the first portion of the signal. The still image is stored in the memory (418). Processing of the second portion of the signal to generate the still image may include performing one or more compression processes such as a JPEG image compression process. Storing of the still image in memory may include storing the image as a separate file (e.g., a JPEG file) or may include encoding the still image as a portion of the continuous video footage. In some embodiments, the still image is stored as an I-Frame in an H.264 compression scheme. For example, to increase compatibility, embodiments of the invention could keep the I-Frame the same size as the rest of the video stream but store the difference data as out-of-bound data. In some embodiments, the still image may then be further processed to have a lower resolution similar to the resolution of the first section of continuous video.

For example, a first frame of video (e.g., frame 1) may be captured as a High-resolution Frame (e.g., 5 megapixels) and processed into a high-resolution I-Frame and/or a high-resolution JPEG, thereby being stored as a still image. The high-resolution I-Frame and/or the high-resolution JPEG may then be processed and stored as the first frame of a lower-resolution (e.g., 1 megapixel) video sequence. The next several frames (e.g., frames 2-20) may be captured as Video-resolution frames (e.g., 1 megapixel) and processed into an I-, P-, or B-frame of the video sequence. The next frame (e.g., frame 21), similar to the first frame, may be a High-resolution Frame processed into a high-resolution 1-Frame and/or a high-resolution JPEG, thereby being stored as a still image. The high-resolution I-Frame and/or the high-resolution JPEG may then be processed and stored as the next frame of a lower-resolution video sequence. Accordingly, frames 2-20 in the example comprise the first portion of the signal and each of frames 1 and 21 comprise the second portion of the signal.

Thus, embodiments of the present invention provide a system and method in which still images are captured concurrently with the video footage and without a user input to initiate the still image capture process. In contrast with conventional systems in which a user provides an input such as pushing of a capture button in order to initiate still image capture, the embodiments described herein function to capture still images in the background without a particular user input. In referring to user input in relation to still image capture, the term “user input” is not intended to include user interactions to define setup parameters for the digital video camera or for the still image capture process. For example, during initial setup of the camera, a user may select a time period between the capturing of subsequent still images. The value of the time period, which may be set to one second by default, can thus be user-configurable through a setup menu. Setting of this parameter by the user is not performed while the digital video camera is receiving a signal from the image sensor during the capture and storage of video frames and thus does not relate to the user input discussed in relation to FIG. 4.

In some embodiment, the method 400 additionally includes processing a third portion of the signal to generate a second section of the continuous video footage (420). The second section of the continuous video footage includes a first frame and a last frame. The first frame of the second section of the continuous video footage follows the last frame of the first section of the continuous video footage sequentially. That is, the first frame of the second section is the frame immediately following the last frame of the first section. In an example in which the video footage is recorded at 30 fps, the first frame of the second section would follow the last frame of the first section by a time period equal to the inverse of the frame rate (i.e., 1/30 second). The second section of the continuous video footage is stored in the memory (422). Thus, the still image is captured during capture of a single piece of video footage in this embodiment and processing the first portion of the signal is performed prior to processing the second portion of the signal, which is performed prior to processing the third portion of the signal. In a specific embodiment, processing the second portion of the video footage includes encoding the video signal using an H.264 codec. In other embodiments, the order of operations is varied. For example, the processing of the second portion of the signal (i.e., the still image portion) may not be performed prior to the processing of the third portion of the signal (i.e., the video portion). Additionally, the still image portion may be processed concurrently with the video portion over the course of a number of frames. It should be noted that according to embodiments of the present invention, the still frame is also reproduced in the video. Thus, still images are captured in a still frame as well as a frame of the video footage, both the still frame and the video frame being characterized by the same time index.

Thus, embodiments of the present invention provide methods and systems to capture still images without user input during capture of continuous video footage. When the image sensor has a pixel resolution higher than the resolution of the video footage (e.g., an 8 MP sensor and 720p HD video (1,280×720 pixels corresponds to approximately 1 MP)), the still images can be captured at resolutions up to the resolution of the still image sensor while the video footage is recorded at the lower resolution after binning or other processing techniques. Thus, in the background, high-resolution still images are captured and stored during recording of the video footage. When a user is subsequently reviewing the video footage, snapshots based on the high-resolution still images can be displayed and used by the user, improving the quality of still images in comparison with conventional techniques and systems.

It should be appreciated that the specific steps illustrated in FIG. 4 provide a particular method of capturing a duration of continuous video footage according to one embodiment of the present invention. Other sequences of steps may also be performed according to alternative embodiments. For example, alternative embodiments of the present invention may perform the steps outlined above in a different order. Moreover, the individual steps illustrated in FIG. 4 may include multiple sub-steps that may be performed in various sequences as appropriate to the individual step. Furthermore, steps may be added or removed depending on the particular applications. One of ordinary skill in the art would recognize many variations, modifications, and alternatives.

According to one embodiment, a second of captured video may include 30 frames at HD quality (e.g., 1280×720 pixels) using binning of the sensor data, and a single frame at the full 8 MP sensor resolution (e.g., 3504×2336 pixels). During video playback, the captured video may be displayed at the native capture resolution (e.g., 1280×720 pixels). However, when a user chooses to extract an image from the video, the captured images at the full 8 MP resolution may be presented as potential extraction candidates. A user may also choose to extract an alternate frame from the video at lower resolution. However, for many still image extraction purposes, the higher resolution still images, although captured at a lower frame rate than the video footage, may be preferable to a user since the still images captured at the full sensor resolution may be much higher quality than the regular video frames.

In an alternative embodiment, the high-resolution frames of a video may be compressed to the size of regular video frames. In this embodiment, a copy of one or more of the full high-resolution frames may be stored as a separate file that may be accessed and independently viewed.

In yet another alternative embodiment, still images with a resolution lower than the full sensor resolution, but higher than the typical resolution used to store frames associated with the video, are captured and stored. In this embodiment, the number of “intermediate” resolution frames captured during video recording may be increased. Rather than capturing a single high-resolution frame every 30 frames (e.g., at the full 8 MP sensor resolution), an intermediate resolution image (e.g., a 3 MP still image) can be captured at a rate less than the video frame rate (e.g., every 1/10 of a second). In this example, three 3 MP frames could be captured for every thirty video frames captured. Although the 3 MP frames in this example are of a lower resolution than the 8 MP frame potentially available, the quality of the still images is still significantly higher than that of the HD video frame (e.g., approximately 1 MP) and the user may have three times as many intermediate quality images to choose from in comparison to a single still image at full resolution. This embodiment may be implemented as a user-defined setting on the digital video camera in a manner similar to the image resolution setting available in digital still cameras.

Some embodiments of the present invention capture high-resolution still images on a periodic basis, for example once per second or every 30 frames of video footage. As discussed above, the time period between capture of subsequent still images can be set as a user-defined option in some embodiments. Other embodiments utilize logic or algorithms to identify and then capture “interesting” still images during video recording. For example, an automated program could select individual frames for capture based, not on a particular time delay, but on one or more parameters or metrics set by default or based on user input during a setup process.

Identifying and capturing a well-chosen, interesting image or several interesting images, may provide the user with more and better still images than available using a set time delay between subsequent still images. Metrics associated with utility for still images include, but are not limited to determining whether:
the image in the frame is sharp;
the image includes brightness, contrast, and/or color that are likely to read well;
the image includes one or more faces of people;
people's eyes are open in the image;
the image is different from other frames in the video based on a metric;
the image is different from other interesting frames in the video; and/or
the image spaced is in time by a certain amount from other interesting frames (e.g., a set of quasi-evenly spaced frames is more representative of the video than a set of frames from only one part of the video).

In some embodiments, one or more of the above listed metrics may be utilized to provide a single metric that is a combination of one or more metrics. Depending on the particular application, a weight may be given to the component metrics and the algorithm could be tuned to optimize the weights. It is known that some images tend to be sharper or more crisp than other images. Thus, the weight given to image sharpness can be varied to increase or decrease the importance given to image sharpness in selecting interesting frames for capture as still images. Additional description related to metrics for still image capture is provided in co-pending and commonly assigned U.S. patent application Ser. No. 12/422,874, filed on Apr. 13, 2009, the disclosure of which is hereby incorporated herein by reference in its entirety for all purposes.

In some embodiments, logic may also be employed to alter the rate at which high-quality frames are captured based on an evaluation of the content of a scene. For example, relatively few high-quality frames may be generated for a 10 second video clip of a stationary object, such as a mountain or other landscape scene. Conversely, an increased number of high-quality frames may captured when a video sequence includes fast motion or significant action, for example, during a sporting event. Additional scene elements may also be detected, such as faces and blinking, to ensure that desirable high-quality still images are captured during video capture.

In some embodiments, captured video frames may be evaluated at one or more times during capture, for example, while still in the memory buffer (i.e., before being encoded or written to a non-volatile memory) in order to determine whether there is a high likelihood that a still image captured close to the evaluated frame would have desirable properties for use as a high-resolution still image.

In a specific embodiment, face detection technology is utilized to modify the rate at which still images are captured and stored. The presence of faces in a video frame may increase the still image capture rate and detection of additional people coming into the frame would result in an addition increase in the still image capture rate. In some embodiments, smile detection technology could also be used to determine when to capture a still image. Other embodiments use an audio signal to determine relevant scenes that may be suitable for still image capture, for example, phrases such as “Cheese,” “Smile,” “Happy Birthday,” or the like could be used to initiate either a still image capture or an increase in the rate of still image capture. Time-based weights could be applied to these metrics, resulting in the value of the audio coefficient decreasing as a function of time after the initial audio signal is detected. Thus, based on the logic provided in the digital video camera, the camera is “automatically” choosing when to capture high-resolution still images. In contrast with conventional systems in which a switch, button, or other user input device is utilized switch from video mode to still image mode or to capture a still image during capturing of video footage, embodiments of the present invention capture high-resolution still images while video footage is being captured with no user input required.

In addition to embodiments of the present invention that provide methods and systems that capture a high-resolution still image while concurrently capturing video footage at a lower resolution, interpolation can be used so that video frames stored at the lower resolution value can be enhanced using adjacent still images stored at higher resolution. For example, in an embodiment in which 8 MP images are captured every 30 video frames a user can extract and use one of the 8 MP images as a screenshot. If the particular action on the video that the user is interested in capturing as a still image occurs at a time between the high-resolution images, the user can select one of the lower resolution frames and image processing software can utilize one or more of the adjacent high-resolution still images to enhance the quality of the intermediate, lower resolution image extracted from the video footage. An analogy from video encoding is the use of an I-frame to enhance data in a P-frame.

Embodiments of the present invention provide unique functionality in the context of digital camcorders, such as a Flip™ Video Camcorder provided by Pure Digital Technologies, Inc. For example, since some camcorders utilize a single record button, the methods and systems described herein enable a user to capture high-resolution images without any user input during video recording, such as pushing a separate shutter button to capture the high-resolution image. Additionally, as described throughout, logic can be utilized to capture the images before the user could operate such a button. Thus, embodiments provide methods that prevent the common occurrence of seeing an opportunity to capture a still image, but having the opportunity pass by before the image can be captured. An example would be at a sporting event. The logic could cue off of a rapid rise in audio volume, capturing an image of the action at a critical time, a time which usually passes before the user is able to take an action such as pushing a button to capture the picture.

Thus, embodiments provide for increased functionality for electronic devices that can be referred to as point-and-shoot digital camcorders. In contrast with conventional digital cameras that include a video capture mode or digital camcorders that include a still image capture mode, embodiments of the present invention are applicable to digital video cameras with no discrete mode for still image capture. Such point-and-shoot digital camcorders may provide only a single button for performing recording functions (i.e., no separate shutter button for capturing of still images) and no separate mechanical mode selector for video/still images (e.g., typically a rotating dial with detents at positions around the dial), which is commonly present on digital cameras with video recording capability.

Thus, embodiments of the present invention provide unique solutions in the context of the simplicity and convenience of the FIip™ camcorder. It is generally accepted that some of the exceptional success of the FIip™ brand has resulted from the ease of use resulting from the clean and uncluttered user interface. The single red button used to start/stop video recording provides a level of usability not available with conventional camcorders. In light of these benefits from the clean user interface design, embodiments of the present invention are developed to increase the device functionality while still maintaining the design elements that have contributed to the success of the Flip™ TM brand.

In a particular embodiment, a camcorder may include an 8 MP image sensor. During decimated video capture at a resolution of 1280×720 pixels, an 8 MP still image is captured every 30 frames (i.e., one still image per second). The still image is compressed and stored in flash memory as part of the compressed video bitstream. If the user connects the camcorder to a personal computer (e.g., by plugging in a built-in USB connector into the personal computer), the video software may start automatically. Initially, the presence of the high-resolution images in the bitstream is transparent to the user. As the video is played-back through the computer, the still images are extracted from the video bitstream and stored in memory, preferably on the computer, but potentially on the camcorder. In one embodiment, when the user selects a “Take Snapshot” function, the high-resolution images are presented to the user for use as snapshots, providing much higher resolution snapshots than conventionally available from the video bitstream. A feature could be provided through which a user could extract all the high-resolution still images and have them stored in a folder on the computer, or the like. One of ordinary skill in the art would recognize many variations, modifications, and alternatives. For example, a conventional mp4 decoder would skip the still images and provide a conventional decoded video bitstream.

As processors with increased processing power become available at lower costs, it is envisioned that the rate at which high-resolution images can be captured, compressed, and stored can be increased. Thus, processors that are currently economical might capture and process a high-resolution image every 30 frames. As the processing power increases at the same price point, the capture rate may be increased to one image every 20 frame, every 10 frames, or the like. Moreover, as the pixel density of image sensors increases, higher density still images can be captured and stored according to the present invention. Additionally, as the cost per bit of memory decreases, additional still images can be stored in concert with the higher processing power and higher pixel densities.

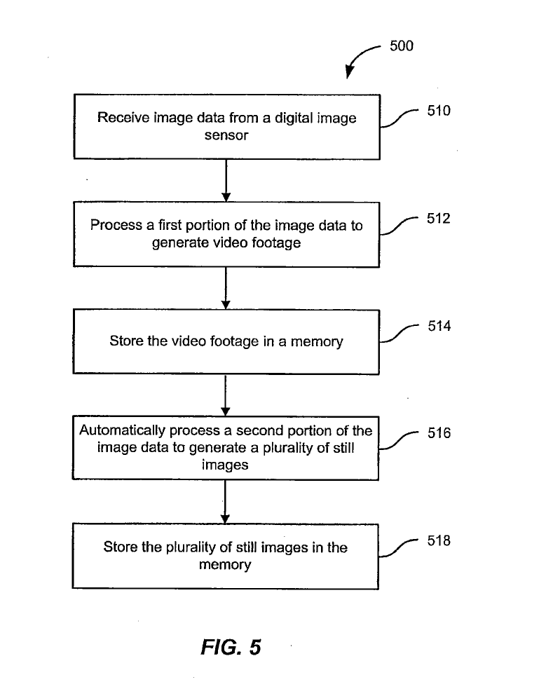

FIG. 5 is a simplified flowchart illustrating a method 500 of operating a digital video camera, according to another embodiment of the present invention. In one embodiment, the method 500 is used to automatically capture a plurality of still images concurrently with the capture of video footage. Using a digital video camera as described herein, still images are captured either on a periodic basis or based on an algorithm designed to select high-quality, high-resolution images for still capture. The method 500 includes receiving image data from a digital image sensor (510). The digital image sensor is characterized by a maximum resolution, for example, 8 MP. The image data is associated with a series of video frames. Thus, embodiments of the present invention transfer data from the image sensor to a processor at a rate based on the desired frame rate of the video footage to be recorded. A first portion of the image data is processed to generate the video footage at a first resolution (512). The first resolution is less than the maximum resolution of the digital image sensor. As examples, the first resolution can be 640×480 pixels, 1280×720 pixels, 1920×1080 pixels, or some other pixel resolution suitable for encoding of video footage. The video footage is stored in a memory (514), for example, a non-volatile memory provided in the digital video camera.

The method 500 also includes automatically processing a second portion of the image data to generate a plurality of still images at a second resolution higher than the first resolution (516). The second resolution may be as high as the maximum resolution of the digital image sensor. Alternatively, the second resolution may be less than the maximum resolution while still being higher than the first resolution. The plurality of still images is stored in the memory (518). Thus, high-resolution still images and video footage at a lower resolution are captured concurrently an in an automated fashion.

In one embodiment, the plurality of still images is generated periodically, for example, every n frames of the video footage. The number of frames between still images can be based on a user-configurable setting of the digital video camera, for example every 30 frames, which is equal to one second for 30 fps video footage. In another embodiment, the plurality of still images is generated in response to logic based on of a characteristic of the signal. For example, an audio portion of the signal may be analyzed to determine timing of the still image capture, for example, the occurrence of certain words or phrases in the video footage. As another example, an image portion of the signal may be analyzed to determine timing of the still image capture, for example, a smiling person, faces in the image, or the like.

It should be appreciated that the specific steps illustrated in FIG. 5 provide a particular method of operating a digital video camera according to one embodiment of the present invention. Other sequences of steps may also be performed according to alternative embodiments. For example, alternative embodiments of the present invention may perform the steps outlined above in a different order. Moreover, the individual steps illustrated in FIG. 5 may include multiple sub-steps that may be performed in various sequences as appropriate to the individual step. Furthermore, steps may be added or removed depending on the particular embodiments. One of ordinary skill in the art would recognize many variations, modifications, and alternatives.

Various embodiments of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as CD-ROM disks readable by a CD-ROM drive, flash memory, ROM chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

It is also understood that the examples and embodiments described herein are for illustrative purposes only and that various modifications or changes in light thereof will be suggested to persons skilled in the art and are to be included within the spirit and purview of this application and scope of the appended claims. What is claimed is:

1. A method comprising:
receiving image data from a digital image sensor that is associated with a series of video frames;
processing a first portion of the image data to generate a first video frame included in a video sequence, wherein the first video frame has a first resolution;
storing the first video frame in a first memory location;
processing a second portion of the image data to generate an image having a second resolution that is greater than the first resolution; and
storing the second video frame in a second memory location.

2. The method of claim 1, further comprising generating a second video frame included in the video sequence by processing the image to reduce the resolution of the image from the second resolution to the first resolution.

3. The method of claim 1, wherein the first memory location and the second memory location are within the same memory device.

4. The method of claim 1, wherein images having the second resolution are automatically generated at periodic intervals related to the frame rate associated with the series of video frames.

5. The method of claim 4, wherein the duration of the periodic intervals is constant or variable.

6. The method of claim 1, wherein images having the second resolution are generated at periodic intervals based on a user-configurable setting.

7. The method of claim 1, wherein the image is generated based on at least one of (a) a sharpness associated with the second portion of the image data, (b) a brightness, a contrast, and/or a color associated with the second portion of the image data, (c) a determination of whether a face of a person is present in the second portion of image data, (d) a determination of whether eyes of a person are closed in the second portion of the image data, and (e) audio associated with the series of video frames.

8. The method of claim 1, wherein the digital image sensor has a maximum pixel resolution that is greater than the first resolution.

9. The method of claim 8, wherein the second resolution is substantially equal to the maximum pixel resolution.

10. The method of claim 1, wherein processing the first portion of the image data to generate the first video frame comprises encoding the first portion of the image data based on an H.264 codec.

11. The method of claim 1, wherein processing the second portion of the image data to generate the image comprises compressing the second portion of the image data based on a JPEG (Joint Photographic Experts Group) compression technique.

12. A computer-readable storage medium storing instructions that, when executed by a processor, cause a computing device to generate video frames, by performing the steps of:
receiving image data from a digital image sensor that is associated with a series of video frames;
processing a first portion of the image data to generate a first video frame included in a video sequence, wherein the first video frame has a first resolution;
storing the first video frame in a first memory location;
processing a second portion of the image data to generate an image having a second resolution that is greater than the first resolution; and
storing the second video frame in a second memory location.

13. The computer-readable storage medium of claim 12, further comprising generating a second video frame included in the video sequence by processing the image to reduce the resolution of the image from the second resolution to the first resolution.

14. The computer-readable storage medium of claim 12, wherein the first memory location and the second memory location are within the same memory device.

15. The computer-readable storage medium of claim 12, wherein images having the second resolution are automatically generated at periodic intervals related to the frame rate associated with the series of video frames.

16. The computer-readable storage medium of claim 15, wherein the duration of the periodic intervals is constant or variable.

17. The computer-readable storage medium of claim 12, wherein images having the second resolution are generated at periodic intervals based on a user-configurable setting.

18. The computer-readable storage medium of claim 12, wherein the image is generated based on at least one of (a) a sharpness associated with the second portion of the image data, (b) a brightness, a contrast, and/or a color associated with the second portion of the image data, (c) a determination of whether a face of a person is present in the second portion of image data, (d) a determination of whether eyes of a person are closed in the second portion of the image data, and (e) audio associated with the series of video frames.

19. The computer-readable storage medium of claim 12, wherein the digital image sensor has a maximum pixel resolution that is greater than the first resolution.

20. The computer-readable storage medium of claim 19, wherein the second resolution is substantially equal to the maximum pixel resolution.

21. The computer-readable storage medium of claim 12, wherein processing the first portion of the image data to generate the first video frame comprises encoding the first portion of the image data based on an H.264 codec.

22. The computer-readable storage medium of claim 12, wherein processing the second portion of the image data to generate the image comprises compressing the second portion of the image data based on a JPEG (Joint Photographic Experts Group) compression technique.

23. A computing device, comprising:
a digital image sensor characterized by a maximum pixel resolution;
a processor coupled to the digital image sensor and configured to:
receive image data from the digital image sensor that is associated with a series of video frames,
process a first portion of the image data to generate a first video frame included in a video sequence, wherein the first video frame has a first resolution that is less than the maximum pixel resolution,
process a second portion of the image data to generate an image having a second resolution that is greater than the first resolution; and
a memory coupled to the processor configured to store the first video frame and the image.
